(19) United States
(12) Patent Application Publication
(10) Pub. No.: US 2008/0144834 A1
(43) Pub. Date: Jun. 19, 2008

(54) Security System Communications Including Encryption

(76) Inventors: Steven Barnett Rakoff, Toronto (CA); Manjeet Ram, Mississauga (CA)

Correspondence Address: CARLSON, GASKEY & OLDS, P.C., 400 WEST MAPLE ROAD, SUITE 350, BIRMINGHAM, MI, 48009, US

(21) Appl. No.: 11/587,681

(22) PCT Filed: Apr. 29, 2005
(86) PCT No.: PCT/US05/14990

§ 371 Date: Aug. 17, 2007

Related U.S. Application Data
(60) Provisional application No. 60/566,879, filed on Apr. 30, 2004.

(51) Int. Cl. H04L 9/08; H04L 9/28; H04L 9/12

(52) U.S. Cl. 380/278; 380/28; 380/277

(57) ABSTRACT

A security system (20) includes a plurality of sensors (22-26) that provide an indication of a security condition to a corresponding plurality of microcontrollers (32-36). Each microcontroller communicates information regarding the security condition to a central control (40). The communications from the microcontroller include using an elliptical public key encryption for protecting a key associated with the security condition information. In a disclosed example, the security condition information is encrypted using a symmetrical encryption technique.

### FIELD OF THE INVENTION

This invention generally relates to security systems. More particularly, this invention relates to communicating security system information.

### DESCRIPTION OF THE RELATED ART

Security systems are well known and in widespread use. Typical systems include at least one sensor such as a motion detector, camera or a position detector that detects a position of a door or window, for example. The sensors provide information regarding a security condition of an object or location of interest. Typical arrangements include a microcontroller that receives an indication from the sensor regarding the security condition. The microcontroller then communicates information regarding the detected security condition to another location using public communication channels like telephone lines or the internet.

Such communications from a microcontroller have included some form of protection to prevent unauthorized access to the communications. Known techniques, however, are subject to attack and do not provide a desired level of protection for the communicated information for all circumstances. For example, some microcontrollers do not use any key exchange for purposes of communicating information over a publicly available telephone line or internet connection, for example. Different parse phrase or transmit techniques have been used to provide some level of protection. Other techniques include using a key but providing that key by another route different than the route used for communicating the security condition information. While adding a key in this manner provides additional protection, it has several drawbacks. Providing a key via another route involves additional expense and complexity that reduces the possible efficiency of the security system.

A significant drawback associated with previous attempts at protecting information communicated by microcontrollers associated with security system devices is that any password or key information typically had to be made available to a variety of individuals who work with the system. This approach makes key management and key security difficult. The more people who know a password or a key, the less secure it inherently becomes.

Cryptographic techniques have been developed for protecting information that is communicated in a manner that is susceptible to interception. One known cryptographic technique for protecting a public key associated with transmitted information is known as RSA encryption. Typical arrangements include using public key cryptography techniques include using a slow speed public key encryption to exchange a key for bulk encryption of associated information. For example, RSA encryption is often used to encrypt a key while the known 3DES symmetrical encryption is used for encrypting information associated with the key.

This approach has not been useful for security systems. The microcontrollers embedded in typical security system devices are not capable of accomplishing RSA encryption unless a special hardware modification were made. The computational and processing requirements associated with public key cryptography such as the RSA encryption technique are too much for a microcontroller to utilize such a technique. Such modifications are not desirable because they introduce additional expense and complexity. A less-secure, bulk or symmetrical encryption technique can be accomplished using a microcontroller, however, that alone does not provide the desired level of security in all circumstances.

There is a need for an enhanced security system that has better security for communicating security condition information over a publicly available communication channel. This invention addresses that need.

### SUMMARY OF THE INVENTION

This invention includes using an elliptical encryption technique for protecting a key associated with transmitted security condition information that is encrypted using another technique. Using elliptical encryption for protecting the key allows a low cost, low-power microcontroller, such as those typically embedded in security devices, to provide enhanced protection for communicated information.

One example security system includes at least one sensor that detects a security condition. A microcontroller receives an indication of the security condition from the sensor. The microcontroller communicates information regarding the security condition to another device using a key for protecting the information. The microcontroller uses elliptical encryption for protecting the key.

One example security system includes a plurality of microcontrollers that each use an elliptical public key encryption for protecting the key and ultimately protecting the communicated information regarding the security condition. Utilizing the disclosed approach provides significant advantages from an entire system standpoint when one considers that multiple microcontrollers can now be efficiently used with greater security compared to previous arrangements.

An example method of communicating information in a security system includes associating a key with information regarding a security condition. The key is encrypted using an elliptical encryption technique. The information regarding the security condition is encrypted using another technique. In one example, the information regarding the security condition is encrypted using a symmetrical encryption technique.

The various features and advantages of this invention will become apparent to those skilled in the art from the following detailed description. The drawing that accompanies the detailed description can be briefly described as follows.

### BRIEF DESCRIPTION OF THE DRAWING

FIG. 1 schematically illustrates selected portions of a security system designed according to an embodiment of this invention.

### DETAILED DESCRIPTION

This invention includes using elliptical encryption techniques for protecting a key associated with communicated information regarding a security condition. The information itself may be encrypted using another encryption technique such as a symmetrical encryption technique. Using an elliptical encryption technique for protecting the key allows a typical low cost, low-power microcontroller embedded in a security system device to provide enhanced communication protection without requiring modification to the microcontroller or the introduction of a higher power, more expensive controller to accommodate the complexities associated with other types of encryption.

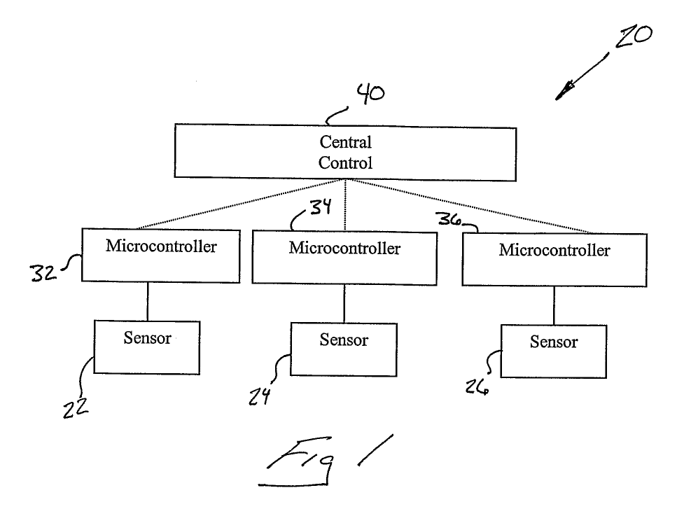

FIG. 1 schematically shows selected portions of a security system 20. A plurality of sensors 22, 24 and 26 provide information regarding various security conditions at various locations. Example sensors include cameras, motion detectors or position detectors that operate in a known manner. In one example, the plurality of sensors are located at different positions within a building or complex. In another example, the sensors 22-26 are located at buildings that are remote from each other.

Each sensor provides an indication regarding a detected security condition (such as an open door or motion within a particular area, for example) to a microcontroller. In this example, the sensor 22 communicates with a microcontroller 32, the sensor 24 communicates with a microcontroller 34 and the sensor 26 communicates with a microcontroller 36.

Each of the microcontrollers communicates information regarding the sensed or detected security condition to a central control device 40. In one example, the central control device is at a remote location compared to that where the sensors and microcontrollers are positioned. Communications between the microcontrollers 32-36 and the central control device 40 are accomplished in one example using publicly available communication facilities such as telephone lines or the internet. To protect these communications, each microcontroller 32-36 associates a key with the information regarding the security condition to be communicated to the central control 40.

In one example, each microcontroller 32-36 encrypts the key associated with the security condition information using an elliptical public key encryption technique. The microcontrollers 32-36 and the central control 40 utilize the elliptical encryption for initially exchanging the key that allows both devices to have a symmetrical key for certification of the associated, communicated security condition information. Prior to the first elliptically encrypted key exchange, the microcontrollers use elliptical encryption for certification where the microcontrollers 32-36 validate the central control 40.

In one example, each microcontroller 32-36 also encrypts the security condition information but uses another type of encryption. In one example, a known bulk or symmetrical encryption technique is used for encrypting the security condition information to protect that information. The central control 40 uses an appropriate technique for deciphering that information after certifying that a proper key exchange has taken place.

With the disclosed example, a low-cost, low-power microcontroller is capable of providing the communication in an encrypted manner that fits within the typical capability of such microcontrollers and still provides better security then relying purely upon symmetrical encryption for the entire communication. The disclosed example provides the ability to have secure communications over publicly available telephone lines or the internet, for example, while still working within the constraints typically imposed by the capability of low cost, low-power microcontrollers.

A significant advantage to the disclosed example is that it allows for existing security system devices such as control panels, access key pads and other system interface devices that have embedded low-power microcontrollers to be suitably programmed to accomplish the results provided by the disclosed example embodiment. This does not introduce any additional cost into the hardware of the system. Moreover, the complexities otherwise associated with trying to manage key information in security systems that rely upon a plurality of microcontrollers are essentially eliminated when employing the disclosed example embodiment. There no longer is any need for an individual or a plurality of individuals to periodically update key information for a plurality of microcontrollers in an attempt to maintain ongoing security. By utilizing elliptical encryption techniques for key information, that key information is far more secure and can be kept constant for a much longer period of time.

The preceding description is exemplary rather than limiting in nature. Variations and modifications to the disclosed example may become apparent to those skilled in the art that do not necessarily depart from the essence of this invention. The scope of legal protection given to this invention can only be determined by studying the following claims.

We claim:

1. A security system, comprising:
at least one sensor that detects a security condition; and
a microcontroller that receives an indication of the security condition from the sensor and communicates information regarding the security condition to another device using a key for protecting the information, the microcontroller uses elliptical encryption for protecting the key.

2. The security system of claim 1, comprising a plurality of said microcontrollers, each using elliptical encryption for an associated key.

3. The security system of claim 2, comprising a central control device that communicates with the plurality of microcontrollers and uses the elliptically encrypted key for certifying the communicated information.

4. The security system of claim 1, wherein the microcontroller uses symmetrical encryption for encrypting the communicated information.

5. The security system of claim 4, wherein the communicated information comprises an alarm protocol.

6. A method of communicating information in a security system having at least one microcontroller that communicates information regarding at least one security condition, comprising the steps of:
associating a key with information regarding the security condition;
encrypting the key using elliptical encryption; and
encrypting the information regarding the security condition.

7. The method of claim 6, including encrypting the information regarding the security condition using another encryption that is different than the elliptical encryption.

8. The method of claim 7, including using a symmetrical encryption for encrypting the information regarding the security condition.

9. The method of claim 6, including communicating the encrypted key and the encrypted information regarding the security condition to a central control device and deciphering the key to certify the communicated information regarding the security condition.

10. The method of claim 6, comprising providing a plurality of sensors each for detecting at least one security condition, providing a plurality of microcontrollers for receiving an indication from corresponding sensors, and using the elliptical public key encryption at each of the microcontrollers.

11. The method of claim 6, including transmitting the encrypted key and the encrypted information in a single transmission.
